(19) United States
(12) Patent Application Publication
(10) Pub. No.: US 2017/0095918 A1
(43) Pub. Date: Apr. 6, 2017

(54) HAND-HELD AND SEMI-STATIONARY SETTING DEVICE

(71) Applicant: Hilti Aktiengesellschaft

(72) Inventors: Dionys Schalbetter, Haag (CH); Julian Keller, Mauren (LI); Markus Sprenger, Mauren (LI)

(21) Appl. No.: 15/128,478

(22) PCT Filed: Mar. 31, 2015
(86) PCT No.: PCT/EP2015/057001

§ 371 Date: Sep. 23, 2016

(30) Foreign Application Priority Data
Apr. 9, 2014 (EP) 14163964.1

(51) Int. Cl. B25C 1/08

(52) U.S. Cl. CPC B25C 1/08

(57) ABSTRACT

The invention relates to a hand-held or semi-stationary setting device for driving fastening elements into a substrate with the aid of a working piston, said device comprising a housing with an attachment device at one discharge end. In order to simplify the operation of a hand-held or semi-stationary setting device, the working piston is coupled to the attachment device such that when driving a fastening element into the substrate, energy of the working piston is absorbed and is transferred to the attachment device, in order to press the attachment device against the substrate.

### TECHNICAL FIELD

The invention relates to a hand-held or semi-stationary setting device for driving fastening elements into a substrate with the aid of a working piston, said device comprising a housing with an attachment device at one discharge end. Furthermore, the invention relates to a method for operating such a setting device.

### PRIOR ART

The German unexamined patent application DE 28 50 273 A1 discloses a powder-powered setting device for driving in fastening elements with a housing and a barrel arranged therein, wherein the barrel is axially movable relative to a part containing a cartridge store, wherein the barrel has in its rear region a shoulder surface which faces away from the driving direction and can be acted upon by the combustion gases, wherein the barrel has in the front region a contact shoulder for axially supporting a support material which can be placed onto the receiving material, and wherein an elastic member is provided between the contact shoulder of the barrel and the support material.

### SUMMARY OF THE INVENTION

The object of the invention is to simplify the operation of a hand-held or semi-stationary setting device for driving fastening elements into a substrate with the aid of a working piston, said device comprising a housing with an attachment device at one discharge end.

In a hand-held or semi-stationary setting device for driving fastening elements into a substrate with the aid of a working piston, said device comprising a housing with an attachment device at one discharge end, the object is achieved in that the working piston is coupled to the attachment device such that when driving a fastening element into the substrate, energy of the working piston is absorbed and is transferred to the attachment device, in order to press the attachment device against the substrate. The hand-held or semi-stationary setting device is operated, for example, with combustion gas, propellant powder, compressed air or electric current. The energy required for driving in the fastening element is transferred to the fastening element by means of the working piston. In contrast to conventional solutions, such as are known for example from the German unexamined patent application DE 28 50 273 A1, the energy for the attachment device not being taken directly, for example from a combustion zone, but by means of the working piston. In the studies carried out in the context of the present invention this has proved advantageous, in particular with regard to a repeatedly reproducible high setting quality.

A preferred exemplary embodiment of the hand-held or semi-stationary setting device is characterized in that the working piston is coupled by means of a spring device to the attachment device. The spring device is preferably arranged between the working piston and the attachment device. In the event of a forward movement of the working piston the spring device is tensioned and transmits a force in the forward direction onto the attachment device. In this case the spring device preferably has a length which corresponds at least to the length of the fastening elements. As a result it is ensured in a simple manner that the driving function of the working piston is maintained.

A further preferred exemplary embodiment of the hand-held or semi-stationary setting device is characterized in that the spring device comprises an elastomeric spring, a spiral spring, a cup spring and/or a fluid spring. Depending upon the application, different springs can be combined with one another. The fluid spring is, for example, a pneumatic spring. The fluid spring can advantageously be equipped with a valve. In order to influence the force profile, the contact time between the working piston 8 and the spring device can be varied, for example, by the length of the spring device. As a result, the transmission of force between the working piston and the attachment device can start earlier or later. Moreover, the spring characteristic of the spring device can be varied.

A further preferred exemplary embodiment of the hand-held or semi-stationary setting device is characterized in that the working piston is coupled by means of a friction and/or clamping device to the attachment device. The friction and/or clamping device is preferably coupled to a guiding device which in turn is advantageously combined with the attachment device. The working piston is preferably guided with one end in the guiding device. By means of a clamping and/or frictional contact an axial force can be transmitted from the working piston to the guiding device. In this case the contact point can be configured in a different way.

A further preferred embodiment of the hand-held or semi-stationary setting device is characterized in that the friction and/or clamping device is designed and arranged so that during driving of a fastening element a part of an axial driving force is transmitted by the working piston to the attachment device. For this purpose the friction and/or clamping device comprises, for example, on the guide body of the guiding device at least one friction and/or clamping element which under a radial pressing force is in contact with the working piston.

A further preferred embodiment of the hand-held or semi-stationary setting device is characterized in that the friction and/or clamping device is designed and arranged so that return of the working piston after a driving operation is not hindered or is only insignificantly hindered. As a result it is ensured in a simple manner that the return of the working piston is not impaired in an undesirable manner by the friction and/or clamping device. With the friction and/or clamping device the force profile can be varied advantageously during a driving operation.

A further preferred exemplary embodiment of the hand-held or semi-stationary setting device is characterized in that the working piston is coupled by means of a magnetic field source to the attachment device. The magnetic field source comprises, for example, at least one magnet, for example an electromagnet or a permanent magnet.

A further preferred exemplary embodiment of the hand-held or semi-stationary setting device is characterized in that the magnetic field source is integrated into a guide body for guiding the fastening elements at the discharge end. The guide body preferably serves not only for guiding the fastening elements. Particularly advantageously the working piston protrudes with one end into the guide body. With the aid of the magnetic field source the guide body can advantageously be coupled to the working piston.

A further preferred exemplary embodiment of the hand-held or semi-stationary setting device is characterized in that the attachment device is combined with a guiding device for guiding the fastening elements at the discharge end. The guiding device advantageously comprises the previously described guide body, which serves for guiding the fastening elements at the discharge end of the setting device. The working piston projects with one end preferably into the guiding device. In this way the coupling of the working piston to the attachment device is simplified. The guide body is, for example, integrally connected to an attachment body which is designed for example as an attachment plate.

In a method for operation of a hand-held or semi-stationary setting device for driving fastening elements into a substrate with the aid of a working piston, said device comprising a housing with an attachment device at one discharge end, in particular a previously described hand-held or semi-stationary setting device, the object set out above is alternatively or additionally achieved in that the working piston is coupled to the attachment device such that when driving a fastening element into the substrate, energy of the working piston is absorbed and is transferred to the attachment device, in order to press the attachment device against the substrate. Obviously, only a part of the energy of the working piston is used for the attachment device. The majority of the energy of the working piston is used for driving in the fastening element.

Furthermore, the invention relates to an attachment device for the previously described hand-held or semi-stationary setting device. The attachment device is available separately.

The setting device according to the invention is preferably a setting device for setting fastening elements, such as bolts. Therefore such a setting device is also designated as a bolt setting device. The setting device is, for example, operated with gas as fuel. The fuel tank is, for example, provided in a gas canister or gas cartridge which is inserted into the setting device.

Further advantages, features and details of the invention are apparent from the following description in which various embodiments of the invention are described in detail with reference to the drawings. In the drawings:

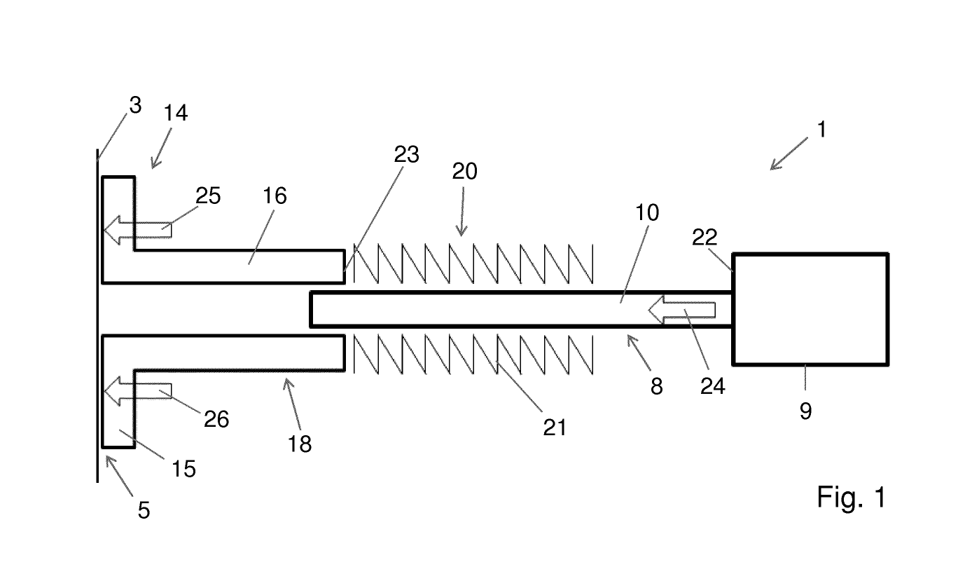

FIG. 1 shows a simplified representation of a setting device according to a first exemplary embodiment, in which a working piston of the setting device is coupled by means of a spring device to an attachment device;

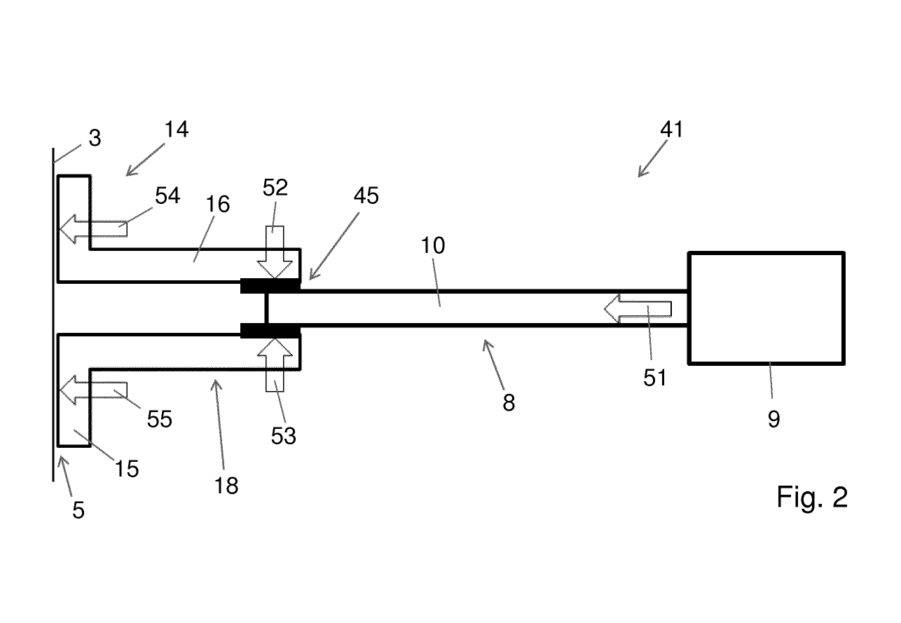

FIG. 2 shows a similar setting device to that shown in FIG. 1, wherein the working piston is coupled to the attachment device by means of a friction and/or clamping device, and

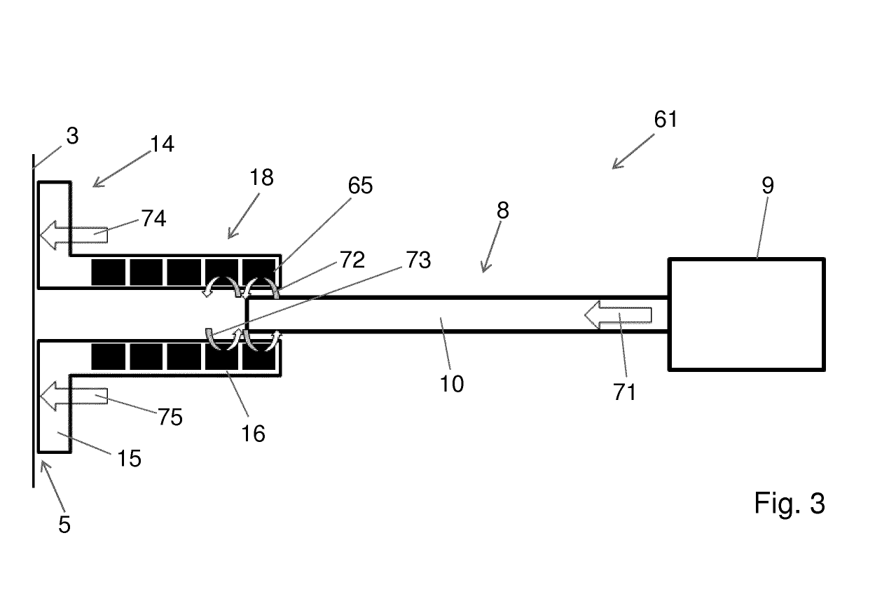

FIG. 3 shows a similar setting device to that shown in FIG. 2, wherein the working piston is coupled to the attachment device by means of a friction and/or clamping device.

### EXEMPLARY EMBODIMENTS

FIGS. 1 to 3 show a setting device 1; 41; 61 according to three different embodiments of the invention in greatly simplified form. With regard to its external structure the setting device 1; 41; 61 designed is in the same or similar way to the powder-powered bolt setting device disclosed in the German unexamined patent application DE 28 50 273 A1.

In FIGS. 1 to 3 the same reference numerals are used to designate the same or similar parts. First of all the common features of the three exemplary embodiments are described below. Then the differences between the three exemplary embodiments will be principally described.

The setting device 1; 41; 61 illustrated in FIGS. 1 to 3 in different exemplary embodiments comprises a housing, not designated in greater detail, having a handle on which the setting device 1; 41; 61 for driving a fastening element into a substrate 3 can be mounted. The fastening element projects out of the setting device 1; 41; 61 at a setting end or discharge end 5.

The fastening elements used are preferably provided by means of a magazine which is located inside the device and is mounted in the vicinity of the discharge end or setting end 5 of the setting device 1; 41; 61. The fastening elements are automatically withdrawn, preferably individually, from the magazine and are provided at the setting end 5.

The energy required for driving the fastening elements into the substrate is provided, for example, in a fuel tank in the interior of the setting device 1; 41; 61. The fuel in the fuel tank is, for example, a liquid gas. Therefore the fuel tank is also designated as a gas canister or gas cartridge.

The fuel tank can be connected by means of an adjustable or regulable metering device with a connecting line to a combustion chamber or a combustion zone. The metering device is preferably designed as a metering valve.

In the combustion zone or the combustion chamber, fuel, that is to say gas, from the fuel tank is mixed with air to produce a combustible mixture which is ignited by an ignition device in order to drive a fastening element, such as a bolt or a nail, into the substrate. When a trigger of the setting device 1; 41; 61 is actuated by means of a working piston 8, the energy required for driving in is transmitted from the combustion chamber to a fastening element at the setting end 5.

The working piston 8 comprises a main body 9, from which a ram 10 extends. Furthermore, the setting device 1; 41; 61 comprises an attachment device 14 which is placed onto the substrate 3 before a fastening element is driven in. The attachment device 14 comprises an attachment plate 15 which is applied to the substrate 3.

The attachment plate 15 is integrally connected to a guide body 16 which is designed as a guide sleeve. The guide body or the guide sleeve 16 serves for representation of a guiding device 18 for the fastening elements to be driven in.

The working piston 8 projects with a free end of the ram 10 into the guiding device 18 so that the ram 10 is guided in the guide body 16. When the fastening element is driven in, the ram 10 is moved further into the guiding device 16 towards the substrate 3, in order to drive the fastening element (not shown) into the substrate 3.

During setting of fastening elements, such as nails or bolts, with conventional setting devices on concrete, chipping frequently occurs because of the nature of the substrate 3. This chipping can reduce the retaining force of the fastening element in the substrate 3. Moreover, the visual appearance of the retaining points on the otherwise relatively smooth substrate surface, for example a concrete surface, is negatively influenced and lowers the confidence in the fastening point.

The extent and frequency of this undesirable chipping can be reduced by the attachment device 14. According to a significant feature of the invention, the energy required in order to press the attachment device 14 against the substrate 3 is supplied by means of the working piston 8. For this purpose the working piston 8 is coupled to the attachment device 14.

In the setting device 1 shown in FIG. 1 the working piston 8 is coupled to the attachment device 14 by means of a spring device 20. The spring device 20 comprises a spiral spring 21 which is arranged in the axial direction between a shoulder 22 formed on the main body 9 of the working piston 8 and an end face 23 of the guide body 16 facing away from the substrate 3.

A movement of the working piston 8 during driving in of a fastening element is indicated by an arrow 24. Due to the associated forward movement of the working piston 8 the spring device 20 is tensioned and transmits a part of the driving force of the working piston 8 to the guide body 16 of the guiding device 18 and the attachment plate 15 of the attachment device 14. In this way the attachment plate 15 of the attachment device 14 is biased against the substrate 3, as indicated by arrows 25 and 26.

In order that the working piston 8 can still completely fulfil its driving function, the spring device 20 should advantageously deflect at least around the length of a fastening element. Unlike the illustration, the spring device 20 can also comprise an elastomeric spring. The spring device 20 can also comprise a pneumatic spring which, for example, builds up a back pressure before the working piston 8.

In order to influence the force profile of the pretensioning force of the attachment device 14, the contact time between the working piston 8 and the spring device 20 can be varied by the length of the spring device 20. As a result the transmission of force can start earlier or later. Moreover, the spring characteristic of the spring device 20 can be varied.

In the setting device 2 shown in FIG. 41 the working piston 45 is coupled to the attachment device 14 by means of a friction and/or clamping device 45. The friction and/or clamping device 45 comprises, for example on the guide body 16 of the guiding device 18, at least one friction and/or clamping element which under a radial pressing force is in contact with the working piston 8.

By means of this contact the working piston 8 can transmit an axial force to the guide body 16 of the guiding device 18 and the attachment plate 15 of the attachment device 14, as is indicated by arrows 51; 52, 53 and 54, 55. In this case the contact point can be configured in a different way. It is important that wear of contact materials during operation of the setting device 41 is taken into consideration. The force profile of the pretensioning force of the attachment device 14 may change due to operationally induced wear of the contact materials.

In order not to impede the return of the working piston 8 after a setting operation, the friction and/or clamping device 45 is preferably designed so that the previously described clamping action only occurs in the event of a forward movement of the working piston 8 in the direction of the arrow 51 in FIG. 2.

During operation of the friction and/or clamping device 45 the force profile of the pretensioning force of the attachment device 14 can be varied over the driving and fastening operation. For this purpose a defined profile can be provided, for example, on the working piston 8. By means of the defined profile the clamping force influenced can be varied according to the piston position.

In the setting device 3 shown in FIG. 3 the working piston 8 is coupled to the attachment device 14 by means of a magnetic field 65. The magnetic field source 65 comprises, for example, a plurality of permanent magnets or electromagnets, indicated by rectangles, in the guide body 16 of the guiding device 18.

With the aid of the magnetic field source 65 an eddy current can be generated in the fast-moving working piston 8 formed from an electromagnetically conductive material. The movement of the working piston 8 during driving in of a fastening element is indicated by an arrow 71.

Eddy currents, by which the working piston 8 is braked relative to the guiding device 18 and the attachment device 14, are indicated by arrows 72 and 73. The associated braking force leads to a pretensioning force, indicated by arrows 74 and 75, of the attachment device 14 onto the substrate 3. The profile of the pressing force can be set, for example, by the spacing between the magnets of the magnetic field source 65 and the working piston 8 or by means of magnets of different strengths.

1. A hand-held or semi-stationary setting device for driving fastening elements into a substrate, the setting device comprising a working piston and a housing with an attachment device at one discharge end, wherein the working piston is coupled to the attachment device such that when driving a fastening element into the substrate, energy of the working piston is absorbed and is transferred to the attachment device, in order to press the attachment device against the substrate.

2. The hand-held or semi-stationary setting device according to claim 1, wherein the working piston is coupled by a spring device to the attachment device.

3. The hand-held or semi-stationary setting device according to claim 2, wherein the spring device comprises an elastomeric spring, a spiral spring (21), a cup spring and/or a fluid spring.

4. The hand-held or semi-stationary setting device according to claim 1, wherein the working piston is coupled by a friction and/or clamping device to the attachment device.

5. The hand-held or semi-stationary setting device according to claim 4, wherein the friction and/or clamping device is designed and arranged so that during driving a fastening element into the substrate, a part of an axial driving force is transmitted by the working piston to the attachment device.

6. The hand-held or semi-stationary setting device according to claim 1, wherein the friction and/or clamping device is designed and arranged so that return of the working piston after a driving operation is not hindered or is only insignificantly hindered.

7. The hand-held or semi-stationary setting device according to claim 1, wherein the working piston is coupled by of a magnetic field source to the attachment device.

8. The hand-held or semi-stationary setting device according to claim 7, wherein the magnetic field source is integrated into a guide body (16) for guiding the fastening elements at the discharge end.

9. The hand-held or semi-stationary setting device according to claim 1, wherein the attachment device is combined with a guiding device (18) for guiding the fastening elements at the discharge end.

10. A method for operating the hand-held or semi-stationary setting device for driving fastening elements into a substrate according to claim 1, the method comprising absorbing and transferring energy of the working piston to the attachment device, in order to press the attachment device against the substrate.

11. An attachment device for the hand-held or semi-stationary setting device according to claim 1.

12. The hand-held or semi-stationary setting device according to claim 2, wherein the friction and/or clamping device is designed and arranged so that return of the working piston after a driving operation is not hindered or is only insignificantly hindered.

13. The hand-held or semi-stationary setting device according to claim 3, wherein the friction and/or clamping device is designed and arranged so that return of the working piston after a driving operation is not hindered or is only insignificantly hindered.

14. The hand-held or semi-stationary setting device according to claim 4, wherein the friction and/or clamping device is designed and arranged so that return of the working piston after a driving operation is not hindered or is only insignificantly hindered.

15. The hand-held or semi-stationary setting device according to claim 5, wherein the friction and/or clamping device is designed and arranged so that return of the working piston after a driving operation is not hindered or is only insignificantly hindered.

16. The hand-held or semi-stationary setting device according to claim 2, wherein the working piston is coupled by a magnetic field source to the attachment device.

17. The hand-held or semi-stationary setting device according to claim 3, wherein the working piston is coupled by a magnetic field source to the attachment device.

18. The hand-held or semi-stationary setting device according to claim 4, wherein the working piston is coupled by a magnetic field source to the attachment device.

19. The hand-held or semi-stationary setting device according to claim 5, wherein the working piston is coupled by a magnetic field source to the attachment device.

20. The hand-held or semi-stationary setting device according to claim 6, wherein the working piston is coupled by a magnetic field source to the attachment device.
